(19) United States
(12) Patent Application Publication
(10) Pub. No.: US 2012/0278091 A1
(43) Pub. Date: Nov. 1, 2012

(54) SALES PREDICTION AND RECOMMENDATION SYSTEM

(75) Inventors: Rahim Mohamed Yaseen, Redwood City, CA (US); Hetal J. Shah, Acton, MA (US); Alex L. Pavlov, Natick, MA (US); Jayashree Manjunath, Acton, MA (US); Manish Bhatia, Bangalore (IN)

(73) Assignee: ORACLE INTERNATIONAL CORPORATION, Redwood Shores, CA (US)

(21) Appl. No.: 13/236,629

(22) Filed: Sep. 19, 2011

Related U.S. Application Data
(60) Provisional application No. 61/384,197, filed on Sep. 17, 2010.

(51) Int. Cl. G06Q 10/00

(52) U.S. Cl. 705/1.1

(57) ABSTRACT

One method can involve accessing a global database of sales cycle information. The global database comprises first confidential information for a first salesperson, where the confidential nature of the first information prevents the first information from being accessed by a second salesperson. The method then generates information indicating a lead for the second salesperson based upon the global database and, in particular, the first confidential information. The method can also generate information indicating a basis for the lead. In one embodiment, the first salesperson works in a different office than the second salesperson.

### RELATED APPLICATIONS

This application claims the domestic benefit under Title 35 of the United States Code §119(e) of U.S. Provisional Patent Application Ser. No. 61/384,197, entitled “Method and Apparatus for Performing Sales Prediction Analysis from Enterprise Data,” filed Sep. 17, 2010, and naming Rahim Mohamed Yaseen, Hetal J. Shah, Alex J. Pavlov, Jayashree Manjunath, and Manish Bhatia as the inventors, which is hereby incorporated by reference in its entirety and for all purposes as if completely and fully set forth herein.

### FIELD OF THE INVENTION

This invention relates to computing and, more particularly, to generating sales predictions in a computing system.

### DESCRIPTION OF RELATED ART

Improving the productivity of a sales force is a challenge. By identifying patterns of sales successes and failures, sales representatives can work to replicate or avoid similar efforts and thereby avoid wasting cycles of cold-calling and uneventful sales activities. Sales patterns can be observed and identified. These patterns offer a window into future buying behavior.

But sales patterns are not readily identifiable to the sale and marketing organization, and therefore it is difficult for the organization to take action to improve sales success. Typical multidimensional analysis of the various factors impacting purchasing by industry, geography, customer size, install base, and the like are often too time-consuming for the sales and marketing groups to undertake.

### SUMMARY

Various systems and methods for generating sales predictions from enterprise data are disclosed. In some embodiments, a method involves accessing a global database of sales cycle information. The global database comprises first confidential information for a first salesperson, where the confidential nature of the first information prevents the first information from being accessed by a second salesperson. The method then generates information indicating a lead for the second salesperson based upon the global database and, in particular, the first confidential information. The method can also generate information indicating a basis for the lead. In one embodiment, the first salesperson works in a different office than the second salesperson.

A system can include one or more processors and memory coupled to the one or more processors. The memory stores program instructions executable to perform a method like the one described above. Similarly, such program instructions can be stored upon a computer readable storage medium.

The foregoing is a summary and thus contains, by necessity, simplifications, generalizations and omissions of detail; consequently those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

A more complete understanding of the present invention may be acquired by referring to the following description and the accompanying drawings, in which like reference numbers indicate like features.

FIG. 1 illustrates a block diagram of a system for generating sales predictions and recommendations, according to one embodiment.

FIG. 2 is a flowchart of a method of generating sales predictions, according to one embodiment.

FIG. 3 is a diagram of another system for performing sales predictions and generating recommendations, according to one embodiment.

FIG. 4 is a block diagram showing how a sales prediction and recommendation system can be used throughout the sales cycle, according to one embodiment.

FIG. 5 illustrates how a sales prediction and recommendation system can be configured and used, according to one embodiment.

FIG. 6 illustrates a logical data model that can be used by a sales prediction and recommendation system, according to one embodiment.

FIG. 7 is a block diagram of a computing system, illustrating how a sales prediction and recommendation module can be implemented in software in at least one embodiment.

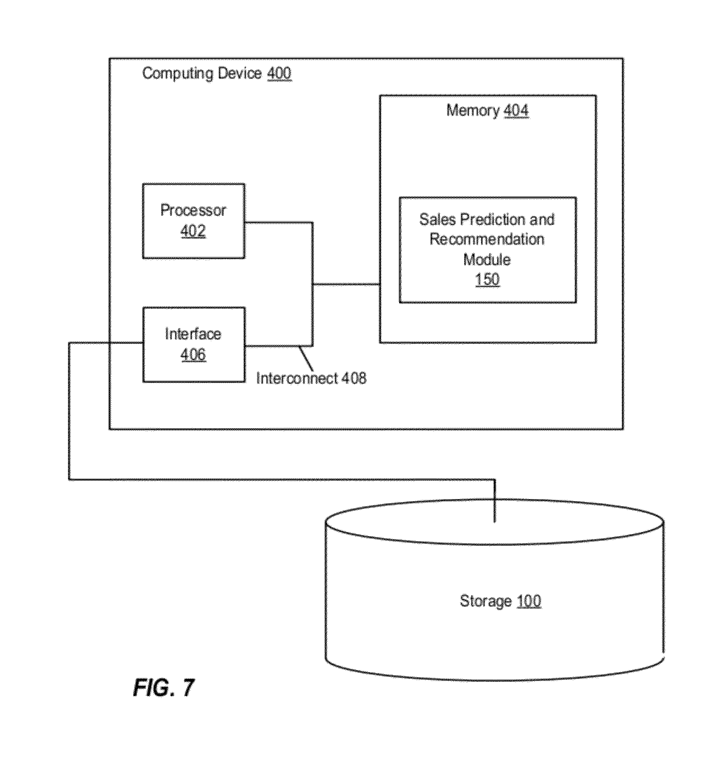

While the invention is susceptible to various modifications and alternative forms, specific embodiments of the invention are provided as examples in the drawings and detailed description. It should be understood that the drawings and detailed description are not intended to limit the invention to the particular form disclosed. Instead, the intention is to cover all modifications, equivalents and alternatives falling within the spirit and scope of the invention as defined by the appended claims.

### DETAILED DESCRIPTION

In a business-to-business (B2B) sales process, marketing typically creates sales leads through marketing campaigns that market products and/or services produced by one business to other businesses. These leads are then each assigned to a sales representative (e.g., based on the sales representative's territory, workload, or expertise) who qualifies the lead according to the potential business customer's readiness and ability to purchase. If the lead passes the qualification criteria, then a contact, an account, and an opportunity are created from the lead. After an opportunity has been created, the sales representative pursues the opportunity and if, possible, creates, a quote for the opportunity. If the potential customer for the opportunity decides to purchase the product or service, then the quote is turned into an order. The sales process can be considered a funnel because each stage of the sales process reduces the number of available items. In other words, there are typically far more leads than opportunities, more opportunities than quotes, and more quotes than orders. The B2B sales process differs from a business-to-consumer (B2C) sales process in that there are no leads, opportunities, or quotes in the B2C sales process; instead, a B2C process only involves orders.

Predictive analysis can be used to assist with various stages of the B2B sales process. Traditionally, leads are generated from trade shows, direct mail campaigns, or advertisements. Predictive analysis can be successfully used to identify which businesses are more likely to positively respond to a marketing campaign. In some eases, a predictive model can be built that uses information about existing business customers to characterize the businesses that are likely to buy a particular product.

In addition to improving the response rate of traditional marketing campaigns, predictive analysis can also be used to analyze a business's existing customer base to determine how to up-sell or cross-sell products and/or services to existing business customers. For example, predictive models can evaluate information about what the customer has previously purchased.

Qualifying a lead can be a complex and elaborate process and the sooner that a lead can be “weeded” out, the less it costs. Predictive analysis can assist in identifying the correct steps to take (or questions to ask) when trying to qualify a lead. Qualifying (or retiring) a lead also presents a valuable opportunity for a predictive system to learn when a lead is more likely to be qualified. A predictive model can be used to rank unqualified leads so that a sales representative focuses on the leads that are more likely to be fruitful. Knowing that unqualified lead could be qualified or was retired provides information that allows predictive analytics to take advantage of both positive and negative information. In other words, qualified leads are positive information and retired leads are negative information with respect to determining which leads can be qualified. In data mining terms, supervised algorithms can be applied to a data set that includes both positive and negative information. Supervised algorithms are typically more powerful than unsupervised algorithms, which can only make use of positive information.

Once a lead has been qualified by a sales representative, the sales representative creates an opportunity from a lead (and possibly an account and/or a contact). At this point, the sales representative is focused on selling to the business customer. An opportunity begins this stage as an open opportunity and may continue through a variety of stages. An opportunity is closed when the sales representative has turned the opportunity into an order or has decided that the opportunity has been lost. While pursuing an opportunity, predictive analytics could be applied to suggest additional products that the sales representative could attempt to include as part of the opportunity. Predictive analytics could certainly play a role in generating the quote by cross-selling, up-selling, or by suggesting pricing.

Predictive analytics can be used to estimate the sales cycle, the likelihood to buy, and the revenue by using historical information about past opportunities that resulted in a sale or not. Predictive analytics can also be used to rank similar successful opportunities that could be used by the sales representative to identify good references. Finally, predictive analytics could be used to rank sales collateral. A sales representative could rate sales collateral based on its effectiveness in pursuing the opportunity.

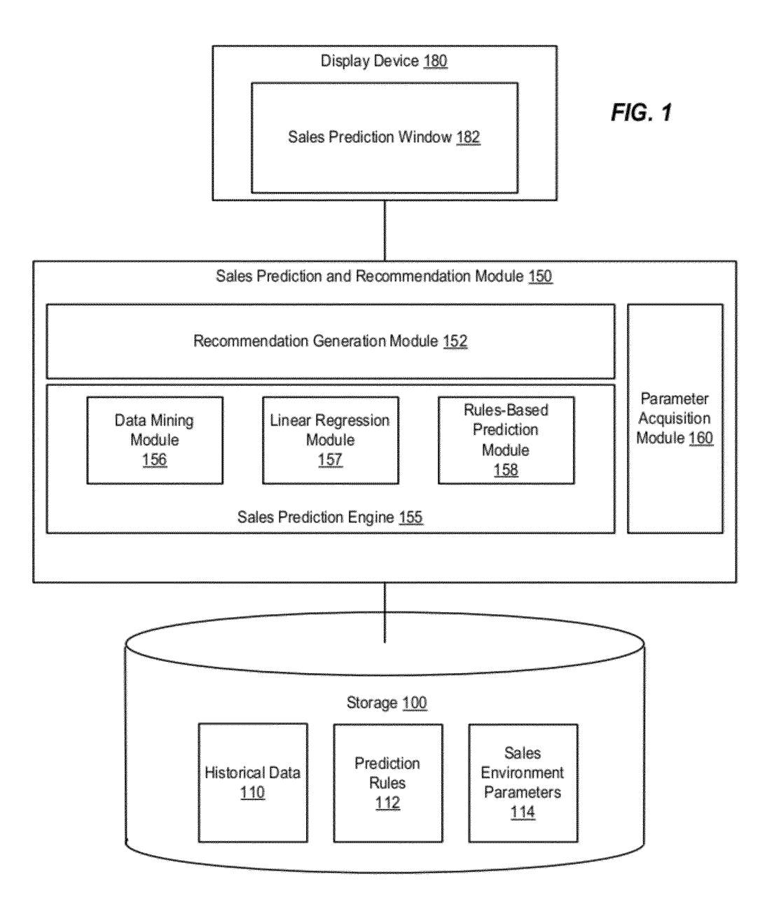

FIG. 1 illustrates a block diagram of a system for performing sales predictions and generating recommendations. As illustrated, the system includes a set of one or more storage devices 100 that stores historical data 110, prediction rules 112, and sales environment parameters 114. Storage 100 is coupled to a sales prediction and recommendation module 150, which includes a sales prediction engine 155 configured to pertain' various types of predictions based upon the information stored in storage 100 to predict leads, opportunities, revenues, and the like.

Sales prediction and recommendation module 150 can also be coupled to a display device 180, which can display a sales prediction window that includes recommendations generated by the sales prediction and recommendation module and/or that allows a user (e.g., a sales representative, sales manager, sales analyst, or the like) to interact with the sales prediction and recommendation module 150.

Historical data 110 can include information from several different databases (e.g., a customer relationship management (CRM) database maintained by a CRM system, an enterprise resource planning (ERP) database maintained by an ERP system, and the like), which can in turn store data that spans an enterprise (e.g., a multinational business can include many different corporate offices, and data for all of these office can be included in historical data 110). As new leads are generated and qualified, new opportunities are generated, new quotes are produced, and new orders are made, information describing each positive or negative outcome obtained during the sales process can be added to historical data 110 (e.g., by the sales prediction and recommendation module 150 or by another system that generates historical data, such as a CRM or ERP system).

Sales prediction and recommendation module 150 includes a recommendation generation module 152 that is configured to generate a recommendation based upon the output of the sales prediction engine 155. The recommendation can include a prediction as well as information indicating the justification for, basis of, and/or confidence in the prediction.

Sales prediction and recommendation module 150 also includes a parameter acquisition module 160. Parameter acquisition module 160 is configured to request a set of parameters describing a sales environment from a sales analyst. These parameters can be used to configure an off-the-shelf sales prediction and recommendation module, which was not designed specifically for use in the specific sales environment but was instead designed to provide generic functionality usable in a variety of sales environments, for use in the specific sales environment described by the parameters.

Sales prediction and recommendation module 150 includes a sales prediction engine 155, which in turn includes a data mining module 156, a linear regression module 157, and a rules-based prediction module 158. In one embodiment, data mining module 156 is configured to generate clustering-based predictions and is implemented using the Oracle™ Data Mining (ODM) software available from Oracle Corporation of Redwood Shores, Calif. Similarly, in one embodiment, linear regression module 157 and rules-based prediction module 158 can be implemented using Oracle™ Real-Time Decision (RTD) software available from Oracle Corporation of Redwood Shores, Calif.

Sales prediction engine 155 can be configured to do a white-space analysis of customers and their assets (e.g., as identified in historical data 110). More specifically, sales prediction engine 155 can use linear regression module 157 and/or rules-based prediction module 158 to generate leads for a specific customers and/or products based on the customer's demographics, their assets (or sales contracts), their service profiles, and/or their sales profiles. Sales prediction engine 155 can return information indicating how customer similarity correlates with owning the product, which indicates the likelihood of a customer to buy the product. Data mining module 156 can be used to estimate the sales cycle and revenue for a particular lead identified by linear regression module 157 and/or rules-based prediction module 158.

Sales prediction engine 155 can also identify opportunities that are similar to an existing opportunity (e.g., identified in historical data 110). Given an opportunity, the sales prediction engine 155 identifies customers that are similar to the customer specified in the opportunity and that have purchased the product specified in the opportunity.

Estimating the likelihood that a customer will purchase a product can be characterized as a regression problem in data mining, which can be used to predict a continuous value based on a set of historical observations. Linear regression, a popular special case of regression, uses a model that depends on a linear combination of the observable attributes to predict the target attribute. More formally, if x₁, x₂, . . . xₙ represent data points in a d dimensional space and y₁, y₂, . . . yₙ represent the target attributes for those data points, then linear regression seeks to find the regression coefficients β₁, β₂, . . . β_{d} and disturbance terms ε₁, ε₂, . . . εₙ such that:

$${y}_{i} = {ɛ}_{i} + {\sum }_{j}^{d} {β}_{j} * {x}_{ij} .$$

Most linear regression techniques assume that n>d and that there is no noise in the data points themselves, but differ in their computational efficiency and their theoretical assumptions about the data. One common technique is to find β that minimizes the sum of the squared deviations as described in the following formula:

$$Sum ( β ) = {\sum }_{i = 0}^{n} {( {y}_{i} - β * {x}_{i} )}^{2} .$$

Linear regression module 157 predicts the likelihood that a customer will purchase a particular product based on customer demographics, sales patterns, service patterns, and assets. Linear regression module 157 can be configured to build a separate predictive model for each product. Linear regression module 157 can build models incrementally and uses a significance threshold that controls how the model will estimate likelihood. If n represents the number of observations, n₊ represents the number of positive observations, i.e., those where the customer has purchased the product, and σ represents the significance threshold, then the following statement describes the step function that is used to predict the likelihood as data is gathered.

if n < σ then there is not enough data to estimate the likelihood
else if n >= σ and n₊ < σ then likelihood = n₊/n
else use the model to predict likelihood

In one embodiment, linear regression module 157 uses a significance threshold of 50, which means that once sales prediction engine 155 has been trained with at least 50 winning opportunities for a product, sales prediction engine 155 will use its linear regression model to predict the likelihood to buy. The significance threshold can be specified in the model defaults for the linear regression module 157. (In one embodiment, linear regression module 157 multiplies the significance threshold by 2 in all of its formulas).

Linear regression module 157 combines the result of “mini” linear regression models that determine the influence of an input value in predicting the likelihood to buy as follows. Linear regression module 157 defines a variable x that indicates whether or not an input value is present in the input and a variable y that indicates whether or not the outcome was positive or not. Since the values of x and y can only be 0 and 1, the linear regression equation that minimizes the sum of the squared deviations can be greatly simplified. Linear regression module 157 can ignore the intercept as it is not directly relevant to the relationship between the input and outcome and interprets the regression coefficient (or slope) β as the influence of x on y. If N is the number of events, Nₓ is the number of times x is 1, N_{y} is the number of times y is 1, N, is the number of times x and y are both 1, and N, is the number of times x is not 1, then for any input value, x, the intercept β can be computed as follows:

$$β = \frac{( N * {N}_{xy} ) - ( {N}_{x} * {N}_{y} )}{( {N}_{x} * {N}_{\sim x} )} .$$

According to the formula if (N*N_{xy})>(Nₓ*N_{y}) then β represents positive correlation or influence, otherwise it represents a negative correlation or influence. The extreme for total positive correlation is achieved when Nₓ=N_{y}=N_{xy}. By substituting in, we get

$$β = \frac{( N * {N}_{x} ) - ( {N}_{x} * {N}_{x} )}{( {N}_{x} * ( N - {N}_{x} ) )} = 1.$$

Likewise, the extreme for negative correlation is achieved when N_{xy}=0 and N_{y}=N−Nₓ. By substituting, we get

$$β = \frac{0 - ( {N}_{x} * ( N - {N}_{x} ) )}{( {N}_{x} * ( N - {N}_{x} ) )} = - 1.$$

Linear regression module 157 can use a modified version of Laplace error correction to combat the problem that arises when small changes in counts for small values of Nₓ, N_{˜x}, N_{y}, N_{˜y}, and N_{xy} produce large changes in the results.

In order to estimate the likelihood, linear regression module 157 sums up the influence of each input value that is present in the target. If there are d input values and xᵢ represents the value of the i-th input value for the target, then the score can be computed as follows:

$$score = {\sum }_{i = 1}^{d} {x}_{i} * {β}_{i} .$$

In order to utilize the preceding simplification where input values are simply binary values, linear regression module 157 transforms attributes into binary criteria. Each category in a categorical attribute gets interpreted as an input value. For example, if the customer industry corresponds to a list of values, then each industry becomes an input value. Similarly, numerical attributes are “binned” to produce categories. For example, the number of employees for a customer might be transformed into the following categories: the number of employees <100, the number of employees >=100 and <500, and the number of employees. Each of these categories becomes a binary input value.

Internally, linear regression module 157 can create some fixed number of buckets for each attribute that needs to be binned. In one embodiment, linear regression module 157 uses the default of 200 for this parameter. As new input data arrives, buckets are added or merged, but never split, in order to maintain the counts that are needed to compute the correlation coefficients. When evaluating a particular input value, linear regression module 157 locates the closest bucket that contains the input value and aggregates neighboring buckets into a bin until the bin has a sample population that meets or exceeds the significance threshold, as defined earlier. The counts within this dynamic bin are used to compute the score.

After computing the score, linear regression module 157 uses a histogram to turn the score into a likelihood prediction. Scores are treated using the same binning algorithm described for numeric input values. Internally, linear regression module 157 maintains a set of buckets for scores. When a positive or negative event is recorded, linear regression module 157 scores the event using its current model and updates the score buckets. If the event is positive/negative, then the positive/negative count for the score's bucket is increased by one. Now in order to turn a score into a likelihood prediction, a dynamic bin is created by locating the closest bucket and aggregating adjacent buckets into a bin until the bin has a sample population is equal or greater than the significance threshold. The number of positive examples/the total number of examples within this dynamic bin is used as the estimate of the likelihood to buy.

The quality of the predictive model depends on a variety of factors, namely the quality of the data, the size of the data, and, more importantly, how well the provided attributes capture the dependencies with the target. To assist someone in evaluating the quality of a model, linear regression module 157 defines a metric called model quality that indicates how reliable a model is at predicting an outcome. Model quality is a numeric value from 0 to 100 that is computed by comparing the model's area under the lift curve to a theoretically ideal model. In one embodiment, a model quality below 30 is not very useful, a model quality of 50 is good, a model quality of 70 is excellent, and a model quality above 95 should be examined to see if the inputs that highly influence the outcome, both positively and negatively, can be obtained in situations where a recommendation is needed.

If the model quality is poor, then one or more of the following problems may be the cause: the model has not seen enough data, the data is noisy, or the data is not predictive enough. To combat these problems, the sales manager can import historical data, clean up the data, or add new attributes to the learning model.

Sales prediction engine 155 can then employ data mining module 156 to use a clustering model to make predictions about the sales cycle and revenue for the lead for which linear regression module 157 generated the likelihood that a customer would buy the product. Data mining module 156 builds two clustering models: one model clusters customers based on their demographics and the second model clusters customers based on which products they own.

In one embodiment, data mining module 156 uses a k-means clustering algorithm for both clustering models. The k-means clustering algorithm partitions the data into a fixed number of clusters so that each data point belongs to the cluster with the nearest centroid and such that the within-cluster sum of squares between a data point and the centroid of the cluster to which it belongs is minimized. More formally, if x₁, x₂, . . . xₙ represent data points in a d dimensional space, k represents the number of clusters, Cᵢ represents the i-th cluster, μᵢ represents the centroid of Cᵢ and distance(xᵢ, xⱼ) represent the distance between two points, then k-means clustering seeks to minimize the following:

$${\sum }_{i = 1}^{k} {\sum }_{x ∈ {C}_{i}} {distance ( x , {μ}_{i} )}^{2} .$$

In one embodiment, for each model, data mining module 156 specifies that the model should be built using automatic data preparation, that 5 clusters should be built and that the split criterion is based on size. The demographic model can use Euclidean distance whereas the Cosine distance is used for the product cluster since the product data is categorical and sparse.

Once built, the demographic and products clustering models are used to populate a recommendation table that includes a row for each demographic cluster, products cluster, and product combination. Thus, if there are 5 clusters in each clustering model and 1000 products, then the recommendation table will have 5×5×1000 rows. In addition to the demographic cluster id, the product cluster id, and the product id, each row also includes the mean, max, min, and average for the sales cycle and revenue the statistics for all of the opportunities that fall within the demographic cluster, products cluster, and product combinations defined by each row.

Once a lead is generated, the revenue and sales cycle are estimated by identifying the appropriate row in the recommendation table as follows. The product for the lead in conjunction with the demographic cluster id, which is determined based on the demographics of the customer for the lead, and the products cluster id, which is determined based on the on the products that the customer for the lead owns, uniquely identifies a row in the recommendation table. The statistics within this table are then used to estimate the sales cycle and revenue.

Sales prediction engine 155 can use the customer clusters described above to determine opportunities that are similar to a specific opportunity. Once built, the demographic and products clustering models are used to populate a similar opportunity table that includes a row for each opportunity. Each row specifies the opportunity id, the demographic cluster id, the product cluster id, and the product id, the sale price, the revenue for the sale, the sales cycle, and the date the opportunity was closed. Sales prediction engine 155 can find similar opportunities by specifying the demographic cluster id, the product cluster id, and the product id. The demographic cluster id and the product cluster id can be obtained from the demographics and assets of the customer for the opportunity and the product id refers to the product being pursued in the opportunity.

Prediction rules 112 are rules that rules-based prediction module 158 can process to replace and/or augment the predictive recommendations provided by data mining module 156 and/or linear regression module 157. Rules 112 can be created and maintained by a sales analyst. These rules-based recommendations are important where sufficient data is not available in historical data 100 to enable the other data-driven predictive modules to generate a lead, such as when a new product (for which there is no preexisting sales data) is being introduced. Examples of situations that may benefit from rules-based predictions include green-field penetration (markets with no previous install base), emerging market penetration (markets will little sales history where model based outputs may not be reliable), and new product launches. Use of rules, however, is not limited to situations where predictive analytics do not apply. Instead, rules can be used to augment the statistical insight granted from model analysis.

Sales environment parameters 116 are parameters that define the specific sales environment in which the sales prediction and recommendation engine can operate. A sales analyst can interact with parameter acquisition module 160 to provide these parameters. Parameters 116 can include information indicating the products that can be recommended by sales prediction and recommendation module 150, information managing the conditions under which the products can be recommended (e.g., such as information indicating which customers are eligible to be offered which products), and information indicating which members of the sales force should be generated leads

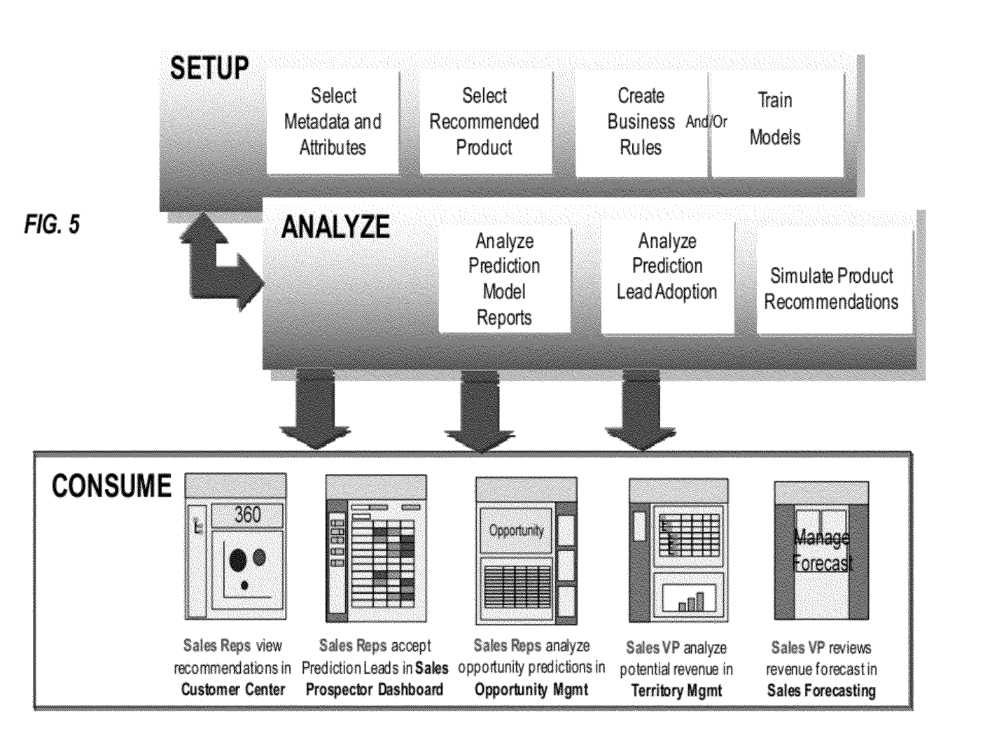

As noted briefly above, leads can generated in one of two ways, either via a predictive model or via predictive rules. FIG. 5 illustrates how, to generate leads via a predictive model, the sales analyst first trains the model. After training, a sales analyst analyzes the predictive model before generating leads. After the sales analyst is comfortable with the predictive model, the sales analysts will likely wish to simulate the results in order to better understand the leads that will be generated. To generate leads via predictive rules, the sales analyst authors recommendation rules. Before generating any leads, the analyst will likely wish to simulate the rules to determine if they are correct. Once the analyst is comfortable with the predictive model and/or the prediction rules, the sales analyst can generate leads from either model based on a variety of conditions, including by territories, by customer profile, etc. Once the leads have been generated and sufficient time has passed, the sales analyst schedules the ongoing model learning and lead generation. The sales analysts, over time, can also assess the effectiveness of the generated recommendations alongside other lead sources.

Returning to FIG. 1, the sales prediction and recommendation module 150 is configured to generate recommendations for members of a sales force. Each recommendation can indicate a customer and a product to attempt to sell to the customer. The recommendation can also include information indicating the likelihood to buy, the predicted length of the sales cycle to convert the lead into an order (indicating the predicted amount of effort needed to convent the lead), the predicted revenue from the lead (indicating the predicted amount of reward from converting the lead), and the like.

The sales leads generated for various sales representatives in a particular territory can also provide a good indication of a territory's potential. The sales prediction and recommendation module can summarize the ‘potential revenue’ associated with the top sales leads identified in each territory irrespective of how the leads are generated. This summary can allow the territory planner to modify territory dimensions to balance the numbers of accounts, opportunities, leads, estimated revenue, and sales representatives.

By analyzing the entirety of historical data 110 when making predictions, sales prediction and recommendation module 150 can provide members of the sales force with insights that they might otherwise be unable to obtain. For example, data relating to leads, opportunities, quotes, and/or orders generated by one salesperson may be maintained confidentially (e.g., in a CRM system). Thus, another salesperson cannot, on their own, access this information in order to attempt to use the information to generate leads or other sales cycle predictions. However, sales prediction and recommendation module 150 has access to this confidential information and can process the confidential information to generate a prediction, which can then be presented to the other sales person.

Storage 100 provides persistent data storage, such that data stored on such a storage device will remain stored even after the storage devices making up storage 100 are powered off. Such a storage device can include, for example, a hard disk, a compact disc (CD), a digital versatile disc (DVD), or other mass storage device, or a storage system (e.g., a redundant array of independent disks (RAID) system or an optical storage jukebox) that includes an array of such storage devices. Such a storage device can also be a virtual or logical storage device that is implemented on such physical storage devices and/or storage systems. For example, such a storage device can be a logical volume that is implemented on a RAID storage system. Additionally, such a storage device can include one or more storage devices. A storage device can also include one or more types of storage media, including solid state media (e.g., Flash drives), optical media (e.g., CDs and DVDs), and magnetic media (e.g., hard disks or magnetic tape). In some embodiments, such storage devices can be implemented using cloud storage, in which the storage device is a logical storage device to which physical storage device(s) are allocated on an as-needed and/or as-contracted basis.

Display device 180 is configured to display graphical and/or textual information to a user. A display device can include an output-only device such as a cathode ray tube (CRT), liquid crystal display (LCD), or plasma monitor. Alternatively, a display device such as a touch screen display can provide both input and output functionality, allowing a user to interact with sales prediction and recommendation module 150 directly via the display device.

Display device 180, sales prediction and recommendation module 150, and storage 100 can be coupled directly (e.g., via a bus, local wireless link, or other appropriate interconnect) or indirectly (e.g., via a network). In one embodiment, these elements are each coupled by one or more networks, which may include a WAN (Wide Area Network), such as the Internet, one or more LANs (Local Area Networks), and/or one or more SANs (Storage Area Networks).

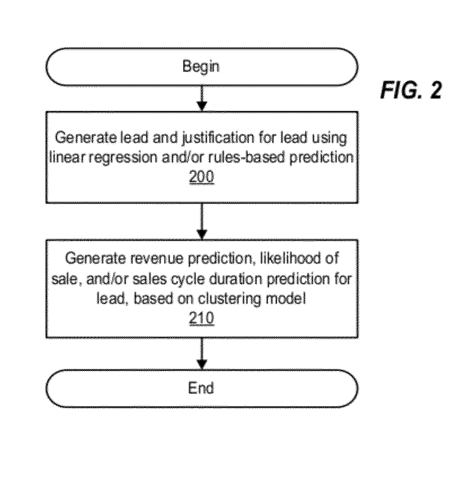

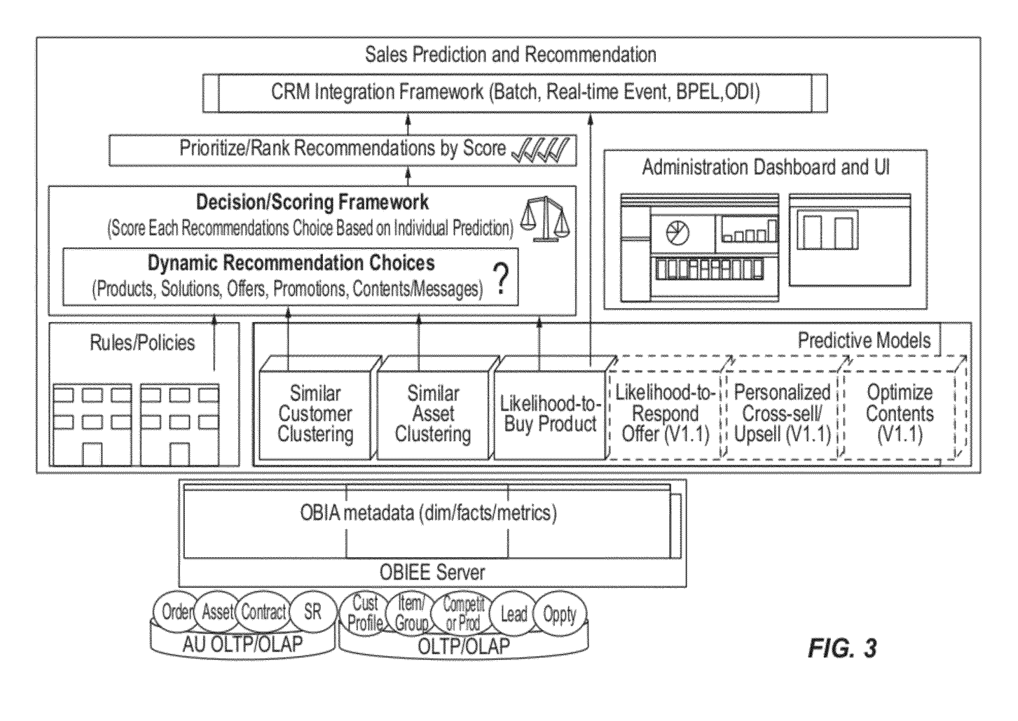

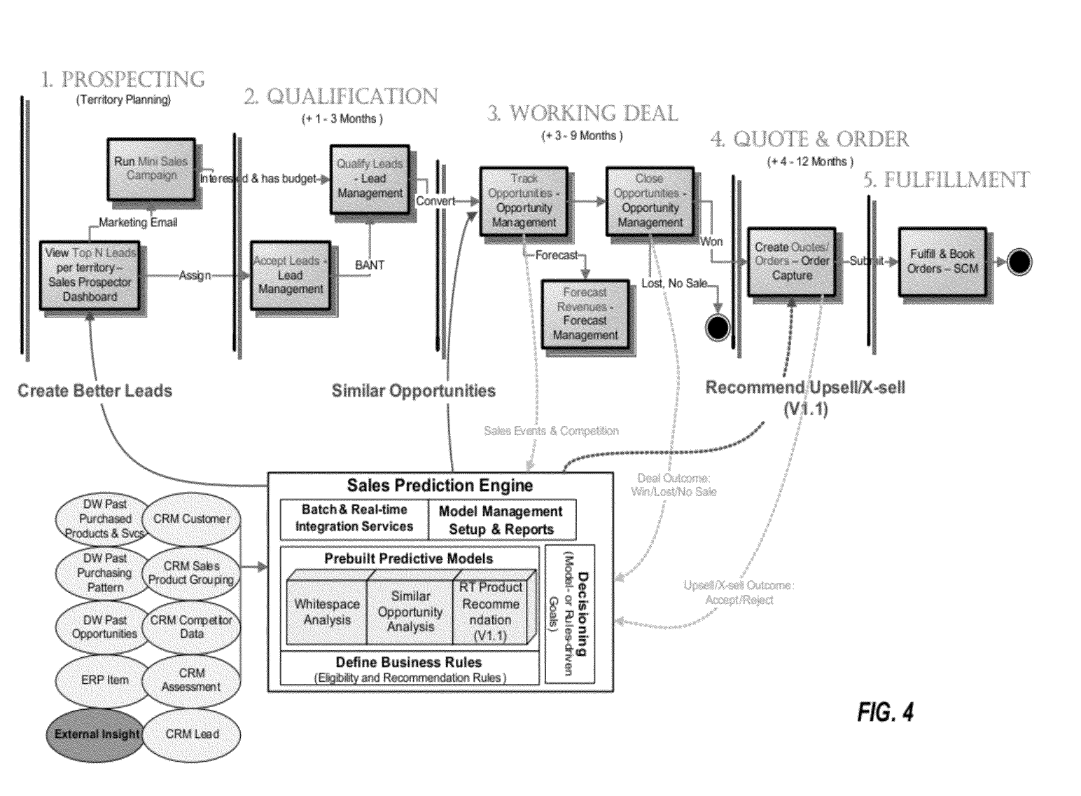

FIG. 2 is a flowchart of a method of generating a sales prediction. FIG. 3 is a diagram of another system for performing sales predictions and generating recommendations. FIG. 4 is a block diagram showing how a, sales prediction and recommendation system can be used throughout the sales cycle.

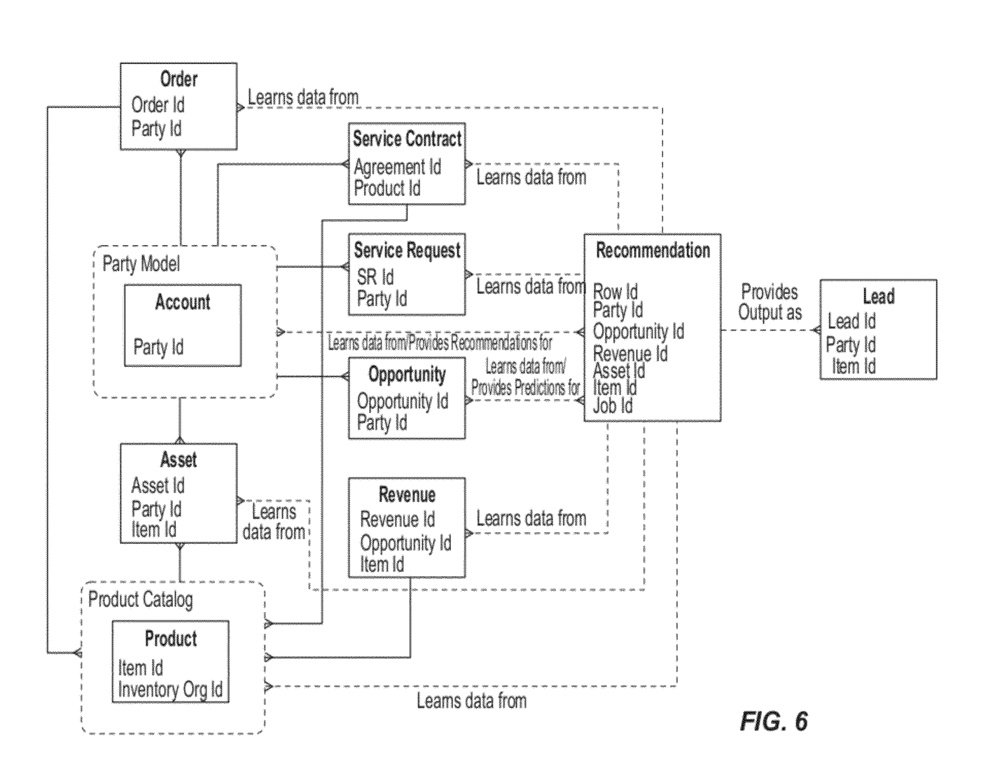

FIG. 6 is a block diagram of a logical data model that can be used by a sales prediction and recommendation module. In this example, the sales prediction and recommendation module generates a recommendation object that includes the prediction. This object can be processed to generate one or more leads to be provided to the sales force, who can choose whether to accept the leads.

The recommendation business object is the result of applying predictive analytics or rules against data that includes various CRM sales data as input and in turn provides a list of recommended products to sell to each customer. The recommendation is a logical grouping of artifacts (product/product group, prediction metrics such as correlation driver, attribute importance, predicted likelihood to buy, revenue, sale cycle values, etc. that are associated to the product/product group) that the sales prediction and recommendation module finds based on the different use cases. There is one recommendation object corresponding to each top eligible and qualified item or product group for all customers/prospects in the Customer Master. Alternately, the company that deploys the sales prediction and recommendation module can choose to store prediction leads for customers/prospects that meet certain criteria (e.g., Industry is equal to High Tech).

The list of customers/prospects for which to generate recommendations can change from job to job. In the case of an overlap of customers between recommendations in different jobs, leads will be generated for the same customer and product combination only if the lead is not yet accepted. In other words, the recommendations shall reflect the latest predicted metrics for each customer.

A recommendation can be displayed in a user interface (e.g., provided by a CRM system that accesses objects created by a sales prediction and recommendation module) as an unaccepted lead where action can be taken. In one embodiment, a Lead is a business object owned by a Lead Management application.

| | |
|---|---|
| Business | Recommendation |
| Object Name | |
| Product Use | Generate recommendations based on White Space Analysis |
| Case | Provide Prospector Prediction leads as One Input to |
| Reference | Territory Alignment Provide Opportunity |
| | Prediction in Opportunity Management |
| Description | Recommendation is a product or service that is offered to |
| | customers based on the prediction model or rules in |
| | Sales Predictor. |
| | Recommendation is not an object Generated by SPE. |
| | The end output from SPE is a lead in Unaccepted Status |
| | with associated predicted metrics: Likelihood to Buy, |
| | Estimated Revenue, and Estimated Sales Cycle. |

Attributes

| Name | Type | Description |
|---|---|---|
| Row ID | Identifier | System generated key |
| Party ID | Identifier | This is the Customer Account ID pointing to |
| | | the TCA record of the target when the target is |
| | | a customer |
| Job ID | Identifier | Processing job foreign key |
| Asset ID | Identifier | Asset foreign key |
| Opportunity | Identifier | Opportunity foreign key |
| ID | | |
| Revenue ID | Identifier | Revenue foreign key |
| Product ID | Identifier | Item foreign key |
| Attribute | Text | Name of the attribute driver |
| Name | | |
| Attribute | Text | Value of the attribute |
| Value | | |
| Maximum | Text | Maximum value of the numeric attribute |
| Attribute | | |
| Value | | |
| Minimum | Text | Minimum value of the numeric attribute |
| Attribute | | |
| Value | | |
| % of | Percent | % of customers with this attribute value that |
| customers | | have purchased the product |
| % diff from | Percent | % of difference of above and the % of all |
| overall | | customers that have purchased the product |
| population | | |
| Created Date | Date/Time | Date of when this driver was captured |
| Last Updated | Date/Time | Date when the record was last updated |
| Date | | |
| Opportunity | Numeric | Total number of events corresponding to |
| Event | | opportunities that are learned by the model |
| Learned | | for a job |
| Num | | |
| Closed | Numeric | Total number of closed opportunity revenues |
| Opportunity | | that are learned by the model and can be used |
| Revenue | | for prediction |
| Learned | | |
| Num | | |
| Likelihood | Numeric | Estimation of the likelihood a customer will |
| to Buy | | purchase the stated product. |
| Average | Numeric | Estimation of the sales review that would result |
| Revenue | | from the sale of a product to the customer |
| | | based on historic data from similar customers |
| | | via data mining. |
| Average | Numeric | Estimation for the sales cycle duration to sell |
| Sales | | the product to the customer based on historic |
| Cycle | | data from similar customers via data mining. |
| Relevance | Numeric | A numeric value generated by RTD which |
| | | signifies the correlation factor of the attribute |
| | | for a particular recommendation |

Various business rules can control how recommendations are generated:

| | |
|---|---|
| Name | Recommending products/product groups already owned |
| Positive Path | Do not recommend products/product groups that customer has already |
| Description | purchased. Check customer asset data to see if customer already owns |
| | products/product groups before recommending the same again. |
| Where Applicable | Sales Lead Generation |
| Requires Profile | |
| Option | |

Error Conditions and Handling (create a row for each error condition)

| | | | Actionable | |
|---|---|---|---|---|
| | | | by | |
| | | | End | |
| Error Condition | Handling | Preventable | User | Diagnostics |
| Duplicate products/product | Handled in ILS/system. No user | Y | N | |
| groups recommended to a | interaction required. | | | |
| customer | | | | |

| | |
|---|---|
| Name | Product eligibility |
| Positive Path | Do not recommend a product or product group that is not eligible to sell |
| Description | to customers. Also if a customer is not eligible to buy certain |
| | products/product groups, do not recommend these to the customer. |
| Where Applicable | Product and customer eligibility |
| Requires Profile | |
| Option | |

Error Conditions and Handling (create a row for each error condition)

| | | | Actionable | |
|---|---|---|---|---|
| | | | by | |
| | | | End | |
| Error Condition | Handling | Preventable | User | Diagnostics |
| Same customer/product | Handled by ILS internal | Y | N | |
| combination was generated | eligibility rule and not by Product | | | |
| as a sales lead where | catalog. | | | |
| ACCEPTED_FLAG = ‘Y’ | | | | |
| Customers not eligible for | Handled by Order Capture web | Y | Y | |
| certain products were | service. | | | |
| recommended with those | | | | |
| products | | | | |

| | |
|---|---|
| Name | Duplicate recommendation |
| Positive Path | Do not recommend same products/product groups that are currently |
| Description | being worked on by sales rep, i.e., for revenue products in an open or |
| | closed-won opportunity. Also, do not recommend the same products. |
| Where Applicable | Sales Lead Generation |
| Requires Profile | |
| Option | |

Error Conditions and Handling (create a row for each error condition)

| | | | Actionable | |
|---|---|---|---|---|
| | | | by | |
| | | | End | |
| Error Condition | Handling | Preventable | User | Diagnostics |
| Same product | Handled in ILS/system. No user | Y | N | |
| recommended as those in | interaction required. | | | |
| an open or closed-won | | | | |
| opportunity | | | | |

| | |
|---|---|
| Name | Lead rejection |
| Positive Path | Do not generate sales leads (customer and product combination) again if |
| Description | the same leads were rejected by sales rep N days ago. This should be |
| | achieved though prediction rules where N days are specified as rejection |
| | within the eligibility conditions. |
| Where Applicable | Sales Lead Generation |
| Requires Profile | |
| Option | |

Error Conditions and Handling (create a row for each error condition)

| | | | Actionable | |
|---|---|---|---|---|
| | | | by | |
| | | | End | |
| Error Condition | Handling | Preventable | User | Diagnostics |
| Same leads were generated | Handled by recommendation | Y | Y | |
| within N days | eligibility in Sales Predictor | | | |

| | |
|---|---|
| Name | Duplicate leads |
| Positive Path | Do not generate duplicate unqualified sales leads with the same |
| Description | customer and product combination for a qualified lead. Don't generate |
| | leads if the lead acceptance flag (ACCEPTED_FLAG in marketing |
| | schema) is set to ‘Y’. |
| Where Applicable | Sales Lead Generation |
| Requires Profile | |
| Option | |

Error Conditions and Handling (create a row for each error condition)

| | | | Actionable | |
|---|---|---|---|---|
| | | | by | |
| | | | End | |
| Error Condition | Handling | Preventable | User | Diagnostics |
| Same customer/product | Handled in ILS/system. No user | Y | N | |
| combination was generate | interaction required. | | | |
| as a sales lead where lead | | | | |
| acceptance flag = ‘Y’ | | | | |

| | |
|---|---|
| Name | Lead source |
| Positive Path | When a lead is generated from Sales Predictor, the lead should be |
| Description | labeled whether it was a lead generated from model or rule prediction in |
| | the lead channel field (CHANNEL_TYPE_CD in marketing schema), |
| | i.e.,: |
| | When a lead is created by prediction rule, set lead channel = “Industry |
| | Insight Prediction” (CHANNEL_TYPE_CD = |
| | ‘ZSP_MODEL_PREDICTION’) |
| | When a lead is created by model, set lead channel = “Data Insight |
| | Prediction” (CHANNEL_TYPE_CD = ‘ZSP_RULES_PREDICTION’) |
| Where Applicable | Sales Lead Generation |
| Requires Profile | |
| Option | |

Error Conditions and Handling (create a row for each error condition)

| | | | Actionable | |
|---|---|---|---|---|
| | | | by | |
| | | | End | |
| Error Condition | Handling | Preventable | User | Diagnostics |
| Sales lead generated from | Handled in ILS/system. No user | Y | N | |
| Sales Predictor, via either | interaction required. | | | |
| model or rule prediction, | | | | |
| does not have a | | | | |
| corresponding lead channel | | | | |

An opportunity object can be used to provide insight about similar opportunities to the sales representative when they are working on the opportunities and/or quote phases of the sales cycle.

| | |
|---|---|
| Business Object | Opportunity |
| Name | |
| Product Use Case | Generate Prediction leads based on White Space |
| Reference | Analysis Provide Opportunity Prediction in |
| | Opportunity Management |
| Description | An opportunity is defined as a potential revenue- |
| | generating event. Opportunity-related information |
| | is recorded and tracked in the views associated |
| | with the Opportunities screen. |

Attributes

| | | |
|---|---|---|
| Opportunity | Identifier | System-generated identifier for the |
| ID | | opportunity record |
| Party ID | Identifier | This is the Customer Account ID pointing to |
| | | the TCA record of the target when the target |
| | | is a customer |
| Status | Code | The current status of the opportunity |
| Created Date | Date | The date when this opportunity is created |
| Created By | Name | User who created the opportunity |
| Sales Method | Code | Sales method drives the sales process and |
| | | can be used to automatically generate |
| | | activities based on sales stage. |
| Sales Stage | Code | The sales stage this opportunity is currently |
| | | at. The value is cross validated by Sales |
| | | Method, which can be defaulted from Users |
| | | Preferences or selected by the user when |
| | | creating the opportunity. |

A revenue object can be used to provide insight (obtained by accessing revenue line items and/or account profile data) about which customers have purchased which products, which can be in turn used for whitespace analysis, as well as to calculate the estimated average revenue and sales cycle.

| | |
|---|---|
| Business Object | Revenue |
| Name | |
| Product Use Case | Generate Prediction leads based on White Space |
| Reference | Analysis Provide Opportunity Prediction in |
| | Opportunity Management |
| Description | Revenue is defined as a child object under opportunity. |
| | Revenue-related information is recorded and tracked |
| | in the views associated with the Opportunities screen. |

Attributes

| Name | Type | Description |
|---|---|---|
| Revenue ID | Identifier | System-generated identifier for the revenue |
| | | record |
| Opportunity | Identifier | Foreign key to opportunity table |
| ID | | |
| Party ID | Identifier | This is the Customer Account ID pointing to |
| | | the TCA record of the target when the target |
| | | is a customer |
| Item ID | Identifier | Foreign key to product table |
| Status | Code | The current status of the revenue |
| Currency | Code | The currency the amount on this revenue line is |
| | | based on |
| Created Date | Date | The date when this opportunity was created |
| Close Date | Date | Estimated closed date of the revenue |
| Created By | Name | User who created the opportunity |
| Revenue | Amount | Amount of the revenue |
| Competitor | Name | Primary competitor of this opportunity |

A lead can be associated with an opportunity either through lead to opportunity conversion process or by manually associating a lead with an opportunity.

| | |
|---|---|
| Business Object | Lead |
| Name | |
| Product Use Case | Generate Prediction leads based on White Space |
| Reference | Analysis Provide Prospector Prediction leads as |
| | One Input to Territory Alignment |
| | Provide Opportunity Prediction in Opportunity |
| | Management |
| Description | A lead is the identity of a human or entity potentially |
| | interested in purchasing a product or service during a |
| | sales or marketing campaign process. |

An account object can be used in whitespace analysis and obtained from account profile information.

| | |
|---|---|
| Business Object Name | Account |
| Product Use Case | Generate Prediction leads based on White Space |
| Reference | Analysis Provide Prospector Prediction leads as |
| | One Input to Territory Alignment |
| | Provide Opportunity Prediction in Opportunity |
| | Management |
| Description | An entity representing the universal truth about |
| | an organization. Account profile data, along with |
| | historical sales data, can be used for whitespace |
| | analysis and similar opportunity analysis. |

An product object can be used in whitespace analysis to determine what product or product group a target customer is likely to buy.

| | |
|---|---|
| Business Object | Product |
| Name | |
| Product Use Case | Generate Prediction leads based on White Space |
| Reference | Analysis Provide Prospector Prediction leads as |
| | One Input to Territory Alignment |
| | Provide Opportunity Prediction in Opportunity |
| | Management |
| Description | A product (or item) in a sales catalog that can be |
| | offered to a customer to satisfy a particular |
| | business need. Sales Predictor also leverages product |
| | groups, or products/services represented in a |
| | hierarchical structure at levels higher than an item. |

An asset object indicates a past purchased product (or service) data in a customer's asset inventory. An asset can be analyzed to detel wine if an asset has an influence on what the future purchases will be.

| | |
|---|---|
| Business Object Name | Asset |
| Product Use Case | Generate Prediction leads based on White Space |
| Reference | Analysis |
| Description | Assets are past purchased products or services of |
| | a customer, usually stored in an asset inventory |
| | system where it can be tracked and maintained as |
| | company properties. The asset data owned by the |
| | customers (i.e. past purchased product data) can |
| | be used to predict what a customer is likely to |
| | buy next. |

A sales order object describes a sales order and can be used in data mining to predict what products or services a customer might buy next.

| | |
|---|---|
| Business Object | Sales Order |
| Name | |
| Product Use Case | Generate Prediction leads based on White Space |
| Reference | Analysis |
| Description | Sales order is an order (may be for products and/or |
| | services) issued by a business to a customer. An |
| | order is a commitment on the part of the customer |
| | to purchase products and services at a specific |
| | price. Sales Predictor in V1 mines sales order data |
| | and metrics available in the 11 g RPD for the white- |
| | space analysis use case. |

A service contract object can be used to store information describing a service contract. This can allow the sales prediction and recommendation module to identify what products or services a customer would likely to buy next based on the service contract data.

| | |
|---|---|
| Business Object | Service Contract |
| Name | |
| Product Use Case | Generate Prediction leads based on White Space |
| Reference | Analysis |
| Description | Service contract (or service level agreement or SLA) |
| | is a part of a contract where the level of service is |
| | formally defined. Sales Predictor is learning on the |
| | Agreement data owned by the customers (i.e. past |
| | purchased services data) to see what a customer is |
| | likely to buy next. |

Historical Service Request metrics (i.e. past servicing patterns) can be accessed to predict what products or services a customer would likely to buy next. As with Sales Order data, the Service Request data would need to come from external system and migrated into the data warehouse before being utilized by the prediction system.

| | |
|---|---|
| Business Object Name | Service Request |
| Business Object | TBD |
| Component Name | |
| Business Object | TBD |
| Component Parent | |
| Name | |
| Status | Post V1 |
| High Volume | Yes |
| Setup Object | No |
| Archive | No |
| Purge | No |
| Data Security | No |
| Required | |
| Product Use Case | Generate Prediction leads based on White Space |
| Reference | Analysis |
| Description | A service request is a customer's request for |
| | information about or assistance with products |
| | or services. Sales Predictor in V1 mines data |
| | from service request metrics available in the |
| | 11 g RPD for the whitespace analysis use case. |
| | Sales Predictor is learning on the aggregate |
| | service request data owned by the customers |
| | (i.e. past servicing patterns data) to determine |
| | what a customer might purchase. |

The sales prediction and recommendation module can perform data mining from various data sources. In one embodiment, we assume this data is migrated to the following metadata entities and the respective dimensions and metrics: account, product, opportunity, revenue, asset, sales order, service contract, Sales Order Patterns/Past Purchasing Patterns, Service Request Patterns/Past Servicing Patterns.

The Account entity represents a profile that describes a company or prospect. In Fusion V1, the Account entity shall be mapped to the HZ_ORGANIZATION_PROFILES (and other relevant HZ) table in the Trading Party Model (TCA). Also, it is assumed that prospects would also have a row in the HZ_ORGANIZATION_PROFILES table, which is populated with market data by the CRM Marketing. The following is a list of Account entity attributes that are probably most significant to a customer's purchase pattern and can be used in the predictive analysis and rules: Annual Revenue, Competitor Flag, Country, Potential Sales Volume, Number of Employees, Industry Name, Line of Business, Revenue Growth Category, Account Type, Partner Flag, Party Type Code, Prospect Flag, Public Flag, Customer SIC Code, State, Account Status, Customer Size, Organization Type, Small Business Indicator, Current Year Potential Revenue, Next Year Potential Revenue, Dun & Bradstreet Rating.

The Product entity represents all items (i.e. products) and parent product groups that appear in the Sales Catalog. Attributes that mapped to Order Capture tables and should be used in decision analysis of product recommendation: Product Name, Product Group Flag, Sales Catalog Hierarchy Base Level Name, Sales Catalog Hierarchy Base Level, Sales Catalog Hierarchy 1, Sales Catalog Hierarchy 1 Name, Sales Catalog Hierarchy 2, Sales Catalog Hierarchy 2 Name, Sales Catalog Hierarchy 3, Sales Catalog Hierarchy 3 Name, Sales Catalog Hierarchy 4, Sales Catalog Hierarchy 4 Name, Sales Catalog Hierarchy 5, Sales Catalog Hierarchy 5 Name, Sales Catalog Hierarchy 6, Sales Catalog Hierarchy 6 Name, Sales Catalog Hierarchy 7, Sales Catalog Hierarchy 7 Name, Sales Catalog Hierarchy 8, Sales Catalog Hierarchy 8 Name, Sales Catalog Hierarchy Top Level, Sales Catalog Hierarchy Top Level Name, Fixed Hierarchy Level.

The Opportunity entity represents either an opportunity that is currently in the sales pipeline or closed previously. An opportunity can have one or many line items (captured by the Opportunity Line Item Entity). The Opportunity Entity can be uniquely identified by the Opportunity ID. The sales prediction module can learns opportunity data for the similar opportunity use cases. Opportunity attributes can include Opportunity Creation Date, Opportunity Close Date, Opportunity Status, Sales Methodology, Sales Channel, Sales Stage, Sales Stage Start Date, Sales Stage Status, Opportunity Source, Sales Source, # of Days in Stage, Opportunity Revenue.

The Revenue entity represents an object that contains item or product group that the sales rep is trying to sell to the customers in an opportunity. Revenue line data store what and when a product was logged against an opportunity and for how much (for closed-won opportunities). Sales Predictor learns on closed-won opportunity revenues for the whitespace analysis and similar opportunity use cases.

An Asset is a single unique instance of a product that a customer purchased. Usually customers store their company assets in an asset or inventory management system for tracking and maintenance reasons. Asset data is the past purchasing data to be used in whitespace analysis use case. Asset module will not be offered as part of the Fusion CRM v1 release; however, the asset data from external system could be migrated into Fusion data warehouse for Sales Predictor to mine.

Sales order is products or services order issued by a business to a customer. As companies collect a ton of information from sales reps (which includes order data) into their CRM system, Sales Predictor learn on these rich sets of data and see if the sales order attributes correlate to what customers would buy next.

Service contract (or service level agreement or SLA) is a part of a contract where the level of service is formally defined. Since service contract is not offered in Fusion V1 release, the data will come from external sources and migrated into data warehouse where Sales Predictor can access via the RPD presentation layer. Currently only a small sub-set of Service Contract attributes is defined in V1, with the expectation that the list would grow once service contract module in Fusion is available.

The Sales Orders Patterns entity consists of a list of derived attributes from the sales order attributes. It is used to account for the customer's purchase pattern during analysis and can include the following attributes: Days Since Last Order, Last Order Revenue, Quarter Ago # of Orders, Year Ago # of Orders, Quarter Ago Total Order Revenue, Year Ago Total Order Revenue, # of Orders.

The Service Request Patterns entity consists of a list of derived attributes from the Service Request attributes. It is used to account for the customer's servicing pattern during analysis. This Service Request Patterns can include the following attributes: Days Since Last Critical SR Closed, # of Critical SRs, # of Open SRs, Quarter Ago # of SRs, Year Ago # of SRs, # of SRs, Year Ago # of Critical SRs.

FIG. 4 is a block diagram of a computing device 400 that illustrates how a sales prediction and recommendation module 150 (e.g., such as sales prediction and recommendation module 150 of FIG. 1) can be implemented in software. Computing device 400 can be a personal computer, network appliance, server, personal digital assistant, mobile phone, storage controller (e.g., an array controller, tape drive controller, or hard drive controller), laptop computer, or the like. In general, computing device 400 is configured to execute software or otherwise provide appropriate functionality as described herein.

As illustrated, computing device 400 includes one or more processors 402 (e.g., microprocessors, Programmable Logic Devices (PLDs), or Application Specific Integrated Circuits (ASICs)) configured to execute program instructions stored in memory 404. Memory 4004 can include various types of Random Access Memory (RAM), Read Only Memory (ROM), Flash memory, Micro Electra-Mechanical Systems (MEMS) memory, magnetic core memory, and the like. Memory 404 can include both volatile and non-volatile memory.

Computing device 400 also includes one or more interfaces 406 (e.g., such as interfaces to a storage device, network, user output device such as a display device, user input device such as a mouse, touch screen, or keyboard, and the like). Processor 402, interface 406, and memory 404 are coupled to send and receive data and control signals by a bus or other interconnect.

Interface 406 can include a network interface to various networks and/or interfaces to various peripheral buses. Interface 406 can also include an interface to one or more storage devices (e.g., such as a storage device, like storage 100 of FIG. 1).

In this example, program instructions and data executable to implement all or part of sales prediction and recommendation module 150 are stored in memory 404. The program instructions and data implementing sales prediction and recommendation module can be stored on various computer readable storage media such as memory 404. In some embodiments, such software is stored on a computer readable storage medium such as a Compact Disc (CD), Digital Versatile Disc (DVD), hard disk, optical disk, tape device, floppy disk, and the like). In order to be executed by processor 402, the instructions and data can be loaded into memory 404 from the other computer readable storage medium. The instructions and/or data can also be transferred to computing device 400 for storage in memory 404 via a network such as the Internet or upon a carrier medium.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

1. A method comprising:
accessing a global database of sales cycle information, wherein the global database comprises first confidential information for a first salesperson, wherein the first confidential information cannot be accessed by a second salesperson; and
generating information indicating a lead for the second salesperson based upon the global database, wherein the generating the information is dependent upon the first confidential information, wherein the accessing and the generating are performed by a computing device implementing a sales prediction engine.

2. The method of claim 1, further comprising generating information indicating a basis for the lead.

3. The method of claim 1, wherein the first salesperson works in a different office than the second salesperson.

4. A method comprising:
generating a first sales cycle prediction for a first salesperson, wherein the first sales cycle prediction is generated by a linear regression module;
generating a second sales cycle prediction for the first salesperson, wherein the second sales cycle prediction is generated by a clustering module, and wherein the second sales cycle prediction is based upon the first sales cycle prediction, wherein the generating the first sales cycle prediction and the generating the second sales cycle prediction are performed by a computing device implementing a sales prediction engine, and wherein the sales prediction engine comprises the linear regression module and the clustering module.

5. The method of claim 4, wherein the first sales cycle prediction is a lead, and wherein the second sales cycle prediction is at least one of a revenue estimate and a sales cycle estimate for the lead.

6. The method of claim 4, wherein the first sales cycle prediction is generated during a first stage of a sales cycle, and wherein the second sales cycle prediction is generated during a second stage of the sales cycle.

7. The method of claim 6, further comprising generating a first set of information describing the first stage of the sales cycle, and wherein the second sales cycle prediction is based upon at least a portion of the first set of information.

8. The method of claim 4, wherein the first sales cycle prediction is based upon one or more sales prediction rules, and wherein the second sales cycle prediction is based upon data identifying historical sales cycle events.

9. A method comprising:
prompting a user for a plurality of parameters, wherein the plurality of parameters define a specific sales environment;
storing the plurality of parameters in a database;
generating a plurality of sales cycle predictions for a plurality of salespeople employed in the specific sales environment, based upon the plurality of parameters, wherein the generating and the prompting are performed by a computing device implementing a preconfigured sales prediction engine.
